(19) United States
(12) Patent Application Publication
(10) Pub. No.: US 2012/0281530 A1
(43) Pub. Date: Nov. 8, 2012

(54) SYSTEM AND METHOD FOR RADIO ACCESS NETWORK OVERLOAD CONTROL

(75) Inventors: Sharad Deepak Sambhwani, San Diego, CA (US); Rohit Kapoor, San Diego, CA (US); Aziz Gholmieh, Del Mar, CA (US); Venkata Ramanan Venkatachalam Jayaraman, San Diego, CA (US)

(73) Assignee: QUALCOMM INCORPORATED, San Diego, CA (US)

(21) Appl. No.: 13/291,028

(22) Filed: Nov. 7, 2011

Related U.S. Application Data
(60) Provisional application No. 61/411,444, filed on Nov. 8, 2010.

(51) Int. Cl. H04W 28/12; H04W 74/08

(52) U.S. Cl. 370/230

(57) ABSTRACT

Methods and apparatuses are provided for access control in a wireless communication system. In particular, certain parameters utilized by access terminals for a random access procedure may be partitioned, such that different classes of access terminals may be controlled independent of other classes. Here, an exclusive set of access classes may be utilized by low-priority machine type communication devices, such that the broadcasting of a bit mask corresponding to the access classes can bar some or all of the low-priority devices. Further, a new access service class may be utilized exclusively by the low-priority devices, wherein the signature space utilized for random access attempts can be partitioned between the new access service class and all other access service classes.

### CROSS-REFERENCE TO RELATED APPLICATIONS

This application claims priority to and the benefit of provisional patent application No. 61/411,444, filed in the United States Patent and Trademark Office on Nov. 8, 2010, the entire content of which is incorporated herein by reference.

### BACKGROUND

1. Field

Aspects of the present disclosure relate generally to wireless communication systems, and more particularly, to access control for mobile devices to reduce or prevent the occurrence an overload.

2. Background

Machine-to-machine communications (M2M) or machine-type communications (MTC) generally refers to communication by autonomous devices over a wireless network such as a 3G network with a server, to report certain information. Some examples of MTC devices include smart meters, e.g., sensors that monitor a home's electricity usage and send usage data to a server at the power company, burglar alarms that can report intrusions, and many other examples. A common feature generally attributed to MTC devices is that the end user is a machine, rather than a human.

One characteristic of many MTC devices is that they may only power-up or attach to the network when they need to do something. For this reason such devices, particularly those with foreign SIMs, are normally not attached to the network and the network may only discover that these devices are in its territory when an event happens, causing the device to report back to its MTC server.

Another characteristic of many MTC devices is that various scenarios may cause large sets of these devices to become activated by the same event. For example, if burglar alarms are deployed with an MTC device, large numbers of them may simultaneously report an event when an earthquake or a power outage occurs. More broadly, any type of MTC devices may simultaneously report if they are configured improperly with the same reporting times.

Thus, the network may suddenly become loaded by very large numbers (possibly into the millions) of the MTC devices, yet potentially the network may have been totally unaware of the existence of these devices. Without prior knowledge of the number of inactive devices in the geographic service area, network capacity planning is quite difficult.

In a further scenario, a number of MTC devices may be deployed into a geographic region by a first network operator. Here, to enhance the coverage area for the MTC devices, the first network operator might equip the MTC devices with SIM cards from their partner network, a second network operator. In this scenario, if the network provided by the first network operator fails, a large number of roaming devices may utilize the network provided by the second operator in a very short time period. For example, when a periodic update by each MTC device fails, that device is likely to change to the network provided by the second network operator. Here, the second network operator may not have planned for such a rapid increase in traffic, and the core network may become overloaded.

For these reasons, a desire exists for a network to be enabled to survive a potentially massive increase in unplanned and unpredicted signaling load. However, in any approach to address the potential overloading of the core network caused by MTC devices, there is a desire that the measures taken affect other users as little as possible. That is, paying subscribers of mobile phones are generally considered higher priority users of the network, and MTC devices may be considered low-priority devices.

Thus, there is a desire to differentiate low-priority traffic and signaling, such as that produced by MTC devices, from other traffic and signaling, and to enable the control of the low-priority traffic and signaling to handle potential core network overload conditions.

### SUMMARY

Various aspects of the present disclosure provide for coarse and fine levels of access control in a wireless communication system. The access control disclosed herein can be particularly useful in controlling machine-type communication (MTC) devices, which might otherwise tend to overload the radio access network and/or the core network.

For example, in one aspect, the disclosure provides a method of wireless communication operable at an access terminal. The method includes receiving a broadcast of an access class bit mask, determining that the access class bit mask is adapted to apply to a set of access terminals exclusive of access terminals outside of the set, and transmitting an access attempt if the received access class bit mask indicates that the access terminal is not barred, or else determining not to transmit the access attempt if the received access class bit mask indicates that the access terminal is barred.

In another aspect, the disclosure provides a method of wireless communication operable at a base station. The method includes detecting a surge in traffic from a set of access terminals, configuring an access class bit mask to bar at least a portion of the set of access terminals, wherein the access class bit mask is adapted to apply to the set of access terminals exclusive of access terminals outside of the set, and transmitting the access class bit mask.

In another aspect, the disclosure provides a method of wireless communication operable at a base station. The method includes detecting the existence of an overload condition, receiving an access attempt comprising a PRACH preamble corresponding to a first access service class exclusively allocated to a set of access terminals, wherein the first access service class comprises at least one random access parameter that is exclusive of any other access service class, and transmitting a negative acknowledgment corresponding to the PRACH preamble to reject the access attempt.

In another aspect, the disclosure provides a method of wireless communication operable at an access terminal. The method includes transmitting an access attempt corresponding to a first access service class exclusively allocated to a set of access terminals, wherein the first access service class includes at least one random access parameter that is exclusive of any other access service class, and receiving a negative acknowledgment corresponding to the first access service class.

In another aspect, the disclosure provides a method of wireless communication operable at a base station. The method includes receiving an overload indicator indicating an overload condition corresponding to one or more access service classes, receiving a first access attempt comprising a first PRACH preamble corresponding to a first access service class from among the one or more access service classes, and transmitting a first negative acknowledgment corresponding to the first PRACH preamble in accordance with the overload indicator.

In another aspect, the disclosure provides a method of wireless communication operable at an access terminal. The method includes receiving a plurality of acquisition indicators, each indicating one of a positive acknowledgment or a negative acknowledgement corresponding to a respective access attempt by one or more access terminals, storing the acquisition indicators in a memory, determining an overload condition in accordance with the stored acquisition indicators, and backing off from transmitting an access attempt in accordance with the overload condition.

In another aspect, the disclosure provides a method of wireless communication operable at a base station. The method includes detecting the existence of an overload condition, transmitting an indicator of the overload condition to a core network, receiving an instruction to bar at least a portion of access terminals utilizing a first access service class, and barring at least a portion of access attempts from the access terminals utilizing the first access service class.

In another aspect, the disclosure provides an access terminal configured for wireless communication. The access terminal includes means for receiving a broadcast of an access class bit mask, means for determining that the access class bit mask is adapted to apply to a set of access terminals exclusive of access terminals outside of the set, and means for transmitting an access attempt if the received access class bit mask indicates that the access terminal is not barred, or else determining not to transmit the access attempt if the received access class bit mask indicates that the access terminal is barred.

In another aspect, the disclosure provides a base station configured for wireless communication. The base station includes means for detecting a surge in traffic from a set of access terminals, means for configuring an access class bit mask to bar at least a portion of the set of access terminals, wherein the access class bit mask is adapted to apply to the set of access terminals exclusive of access terminals outside of the set, and means for transmitting the access class bit mask.

In another aspect, the disclosure provides a base station configured for wireless communication. The base station includes means for detecting the existence of an overload condition, means for receiving an access attempt comprising a PRACH preamble corresponding to a first access service class exclusively allocated to a set of access terminals, wherein the first access service class comprises at least one random access parameter that is exclusive of any other access service class, and means for transmitting a negative acknowledgment corresponding to the PRACH preamble to reject the access attempt.

In another aspect, the disclosure provides an access terminal configured for wireless communication. The access terminal includes means for transmitting an access attempt corresponding to a first access service class exclusively allocated to a set of access terminals, wherein the first access service class comprises at least one random access parameter that is exclusive of any other access service class, and means for receiving a negative acknowledgment corresponding to the first access service class.

In another aspect, the disclosure provides a base station configured for wireless communication. The base station includes means for receiving an overload indicator indicating an overload condition corresponding to one or more access service classes, means for receiving a first access attempt comprising a first PRACH preamble corresponding to a first access service class from among the one or more access service classes, and means for transmitting a first negative acknowledgment corresponding to the first PRACH preamble in accordance with the overload indicator.

In another aspect, the disclosure provides an access terminal configured for wireless communication. The access terminal includes means for receiving a plurality of acquisition indicators each indicating one of a positive acknowledgment or a negative acknowledgement corresponding to a respective access attempt by one or more access terminals, means for storing the acquisition indicators in a memory, means for determining an overload condition in accordance with the stored acquisition indicators, and means for backing off from transmitting an access attempt in accordance with the overload condition.

In another aspect, the disclosure provides a base station configured for wireless communication. The base station includes means for detecting the existence of an overload condition, means for transmitting an indicator of the overload condition to a core network, means for receiving an instruction to bar at least a portion of access terminals utilizing a first access service class, and means for barring at least a portion of access attempts from the access terminals utilizing the first access service class.

In another aspect, the disclosure provides a computer program product operable at an access terminal configured for wireless communication. The computer program product includes a computer-readable medium having instructions for causing a computer to receive a broadcast of an access class bit mask, to determine that the access class bit mask is adapted to apply to a set of access terminals exclusive of access terminals outside of the set, and to transmit an access attempt if the received access class bit mask indicates that the access terminal is not barred, or else determining not to transmit the access attempt if the received access class bit mask indicates that the access terminal is barred.

In another aspect, the disclosure provides a computer program product operable at a base station configured for wireless communication. The computer program product includes a computer-readable medium having instructions for causing a computer to detect a surge in traffic from a set of access terminals, to configure an access class bit mask to bar at least a portion of the set of access terminals, wherein the access class bit mask is adapted to apply to the set of access terminals exclusive of access terminals outside of the set, and to transmit the access class bit mask.

In another aspect, the disclosure provides a computer program product operable at a base station configured for wireless communication. The computer program product includes a computer-readable medium having instructions for causing a computer to detect the existence of an overload condition, to receive an access attempt comprising a PRACH preamble corresponding to a first access service class exclusively allocated to a set of access terminals, wherein the first access service class comprises at least one random access parameter that is exclusive of any other access service class, and to transmit a negative acknowledgment corresponding to the PRACH preamble to reject the access attempt.

In another aspect, the disclosure provides a computer program product operable at an access terminal configured for wireless communication. The computer program product includes a computer-readable medium having instructions for causing a computer to transmit an access attempt corresponding to a first access service class exclusively allocated to a set of access terminals, wherein the first access service class comprises at least one random access parameter that is exclusive of any other access service class, and to receive a negative acknowledgment corresponding to the first access service class.

In another aspect, the disclosure provides a computer program product operable at a base station configured for wireless communication. The computer program product includes a computer-readable medium having instructions for causing a computer to receive an overload indicator indicating an overload condition corresponding to one or more access service classes, to receive a first access attempt comprising a first PRACH preamble corresponding to a first access service class from among the one or more access service classes, and to transmit a first negative acknowledgment corresponding to the first PRACH preamble in accordance with the overload indicator.

In another aspect, the disclosure provides a computer program product operable at an access terminal configured for wireless communication. The computer program product includes a computer-readable medium having instructions for causing a computer to receive a plurality of acquisition indicators each indicating one of a positive acknowledgment or a negative acknowledgement corresponding to a respective access attempt by one or more access terminals, to store the acquisition indicators in a memory, to determine an overload condition in accordance with the stored acquisition indicators; and to back off from transmitting an access attempt in accordance with the overload condition.

In another aspect, the disclosure provides a computer program product operable at a base station configured for wireless communication. The computer program product includes a computer-readable medium having instructions for causing a computer to detect the existence of an overload condition, to transmit an indicator of the overload condition to a core network, to receive an instruction to bar at least a portion of access terminals utilizing a first access service class, and to bar at least a portion of access attempts from the access terminals utilizing the first access service class.

In another aspect, the disclosure provides an access terminal configured for wireless communication. The access terminal includes a receiver for receiving a broadcast of an access class bit mask, at least one processor configured to determine that the access class bit mask is adapted to apply to a set of access terminals exclusive of access terminals outside of the set, a memory coupled to the at least one processor, and a transmitter for transmitting an access attempt if the received access class bit mask indicates that the access terminal is not barred, wherein the at least one processor is configured to determine not to transmit the access attempt if the received access class bit mask indicates that the access terminal is barred.

In another aspect, the disclosure provides a base station configured for wireless communication. The base station includes at least one processor and a memory coupled to the at least one processor, wherein the at least one processor is configured to detect a surge in traffic from a set of access terminals and to configure an access class bit mask to bar at least a portion of the set of access terminals, wherein the access class bit mask is adapted to apply to the set of access terminals exclusive of access terminals outside of the set. Here, the base station further includes a transmitter for transmitting the access class bit mask.

In another aspect, the disclosure provides a base station configured for wireless communication. The base station includes at least one processor and a memory coupled to the at least one processor, wherein the at least one processor is configured to detect the existence of an overload condition. Here, the base station further includes a receiver for receiving an access attempt that includes a PRACH preamble corresponding to a first access service class exclusively allocated to a set of access terminals. The first access service class includes at least one random access parameter that is exclusive of any other access service class. The base station further includes a transmitter for transmitting a negative acknowledgment corresponding to the PRACH preamble to reject the access attempt.

In another aspect, the disclosure provides an access terminal configured for wireless communication. The access terminal includes a transmitter for transmitting an access attempt corresponding to a first access service class exclusively allocated to a set of access terminals, wherein the first access service class includes at least one random access parameter that is exclusive of any other access service class. The access terminal further includes a receiver for receiving a negative acknowledgment corresponding to the first access service class.

In another aspect, the disclosure provides a base station configured for wireless communication. The base station includes a receiver for receiving an overload indicator indicating an overload condition corresponding to one or more access service classes, and for receiving a first access attempt comprising a first PRACH preamble corresponding to a first access service class from among the one or more access service classes, and a transmitter for transmitting a first negative acknowledgment corresponding to the first PRACH preamble in accordance with the overload indicator.

In another aspect, the disclosure provides an access terminal configured for wireless communication. The access terminal includes a receiver for receiving a plurality of acquisition indicators each indicating one of a positive acknowledgment or a negative acknowledgement corresponding to a respective access attempt by one or more access terminals, at least one processor, and a memory coupled to the at least one processor. The at least one processor is configured to store the acquisition indicators in a memory, to determine an overload condition in accordance with the stored acquisition indicators, and to back off from transmitting an access attempt in accordance with the overload condition.

In another aspect, the disclosure provides a base station configured for wireless communication. The base station includes at least one processor and a memory coupled to the at least one processor, wherein the at least one processor is configured to detect the existence of an overload condition. The base station further includes a transmitter for transmitting an indicator of the overload condition to a core network, and a receiver for receiving an instruction to bar at least a portion of access terminals utilizing a first access service class. Further, the at least one processor is configured to bar at least a portion of access attempts from the access terminals utilizing the first access service class.

These and other aspects of the invention will become more fully understood upon a review of the detailed description, which follows.

### BRIEF DESCRIPTION OF THE DRAWINGS

FIG. 1 is a block diagram illustrating an example of a hardware implementation for an apparatus employing a processing system.

FIG. 2 is a conceptual diagram illustrating an example of a radio protocol architecture for the user and control plane.

FIG. 3 is a conceptual diagram illustrating an example of an access network.

FIG. 4 is a block diagram conceptually illustrating an example of a telecommunications system.

FIG. 5 is a block diagram conceptually illustrating an example of a Node B in communication with a UE in a telecommunications system.

FIG. 6 is a flow chart illustrating a process for implementing access class barring.

FIG. 7 is a pair of call flow diagrams illustrating an RRC connection establishment procedure.

FIG. 8 is a timing diagram illustrating a portion of a random access procedure in a UTRA network.

FIG. 9 is a schematic diagram illustrating access service classes.

FIG. 10 is a flow chart illustrating a process for configuring a base station to handle random access attempts by low-priority access terminals amid potential overload conditions.

FIG. 11 is a flow chart illustrating a process for implementing a reject by RAN procedure.

FIG. 12 is a flow chart illustrating a process for implementing a reject by RAN procedure.

FIG. 13 is a flow chart illustrating a process for implementing a reject by RAN procedure.

FIG. 14 is a flow chart illustrating a process for implementing a reject by RAN procedure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the present disclosure can broadly apply to any type of device that might be considered to be a low-priority device. As one example, machine type communication (MTC) devices may be considered to have a lower priority than mobile phones or wireless access cards used by ordinary subscribers.

Aspects of the present disclosure provide a system and method to enable isolation of low-priority devices so that those low-priority devices can be controlled relatively independently, that is, without substantially affecting other classes of users. In this way, overloading of the core network by these low-priority devices can be reduced or prevented.

For example, some of the aspects of the present disclosure may provide for a reduction of the signaling load caused by MTC devices without necessarily affecting the signaling load caused by non-MTC devices. Further, aspects of the present disclosure may provide overload control with a granularity of a single SGSN, MME, GGSN, or PGW. Further, aspects of the present disclosure may enable the network selectively to detach the MTC devices, and selectively to deactivate the radio bearers among APNs and MTC device groups. In this way, the network load due to the overload situation can be reduced. Further, aspects of the present disclosure may enable the network to prevent the MTC devices from initiating or sending connection requests too frequently. In this way, network overloads caused by the MTC devices may be reduced or eliminated. Further, aspects of the present disclosure may reduce the hourly signaling peaks from recurring MTC applications. Still further, aspects of the present disclosure may enable a spreading over time of the signaling load of requests from the MTC devices.

In accordance with various aspects of the disclosure, an element, or any portion of an element, or any combination of elements may be implemented with a processing system that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

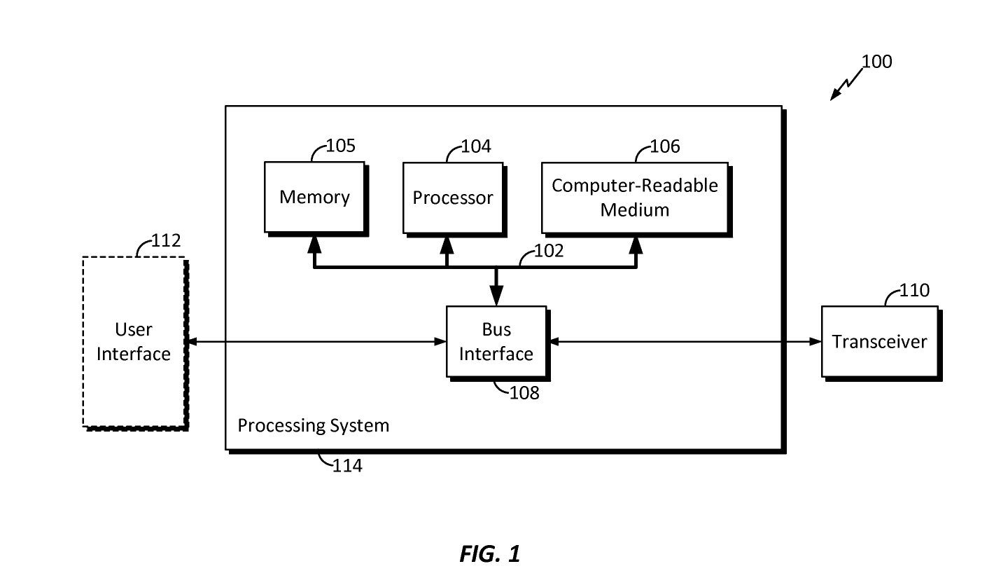

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, a memory 105, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

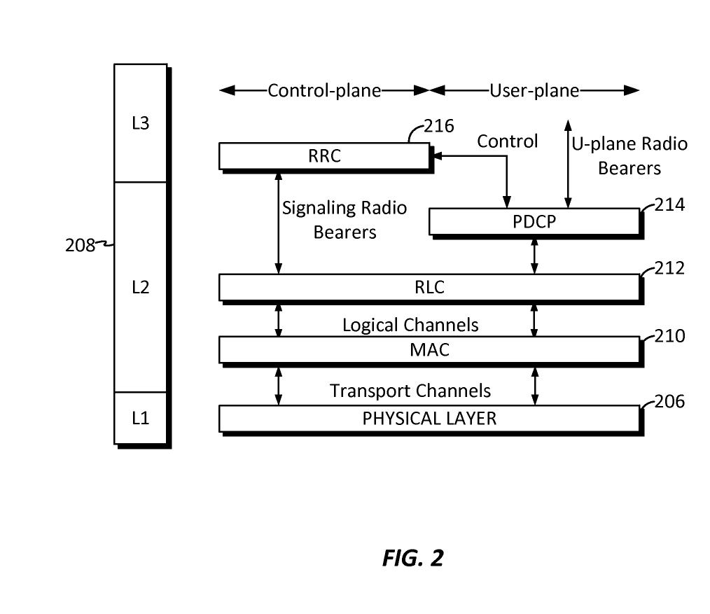

In a wireless telecommunication system, the radio protocol architecture between a mobile device and a cellular network may take on various forms depending on the particular application. An example for a 3GPP UMTS system will now be presented with reference to FIG. 2, illustrating an example of the radio protocol architecture for the user and control planes between user equipment (UE) and a base station, commonly referred to as a Node B. Here, the user plane or data plane carries user traffic, while the control plane carries control information, i.e., signaling.

Turning to FIG. 2, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 206. The data link layer, called Layer 2 (L2 layer) 208 is above the physical layer 206 and is responsible for the link between the UE and Node B over the physical layer 206.

At Layer 3, the RRC layer 216 handles the control plane signaling between the UE and the Node B. RRC layer 216 includes a number of functional entities for routing higher layer messages, handling broadcast and paging functions, establishing and configuring radio bearers, etc.

In the illustrated air interface, the L2 layer 208 is split into sublayers. In the control plane, the L2 layer 208 includes two sublayers: a medium access control (MAC) sublayer 210 and a radio link control (RLC) sublayer 212. In the user plane, the L2 layer 208 additionally includes a packet data convergence protocol (PDCP) sublayer 214. Although not shown, the UE may have several upper layers above the L2 layer 208 including a network layer (e.g., IP layer) that is terminated at a PDN gateway on the network side, and an application layer that is terminated at the other end of the connection (e.g., far end UE, server, etc.).

The PDCP sublayer 214 provides multiplexing between different radio bearers and logical channels. The PDCP sublayer 214 also provides header compression for upper layer data packets to reduce radio transmission overhead, security by ciphering the data packets, and handover support for UEs between Node Bs.

The RLC sublayer 212 provides segmentation and reassembly of upper layer data packets, retransmission of lost data packets, and reordering of data packets to compensate for out-of-order reception due to a hybrid automatic repeat request (HARQ).

The MAC sublayer 210 provides multiplexing between logical and transport channels. The MAC sublayer 210 is also responsible for allocating the various radio resources (e.g., resource blocks) in one cell among the UEs. The MAC sublayer 210 is also responsible for HARQ operations.

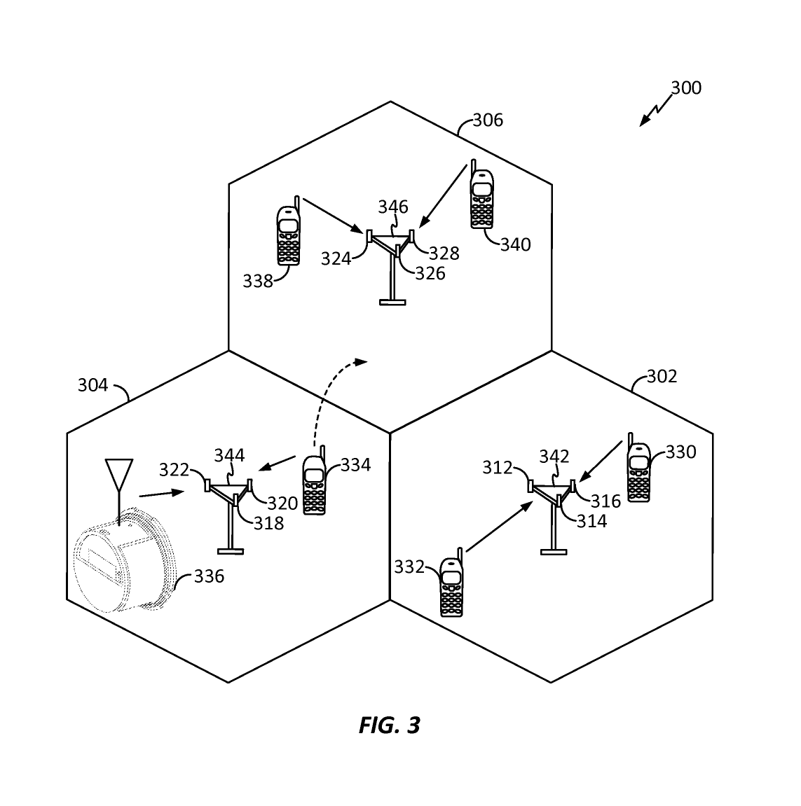

The various concepts presented throughout this disclosure may be implemented across a broad variety of telecommunication systems, network architectures, and communication standards. Referring to FIG. 3, by way of example and without limitation, a simplified access network 300 in a UMTS Terrestrial Radio Access Network (UTRAN) architecture is illustrated. The system includes multiple cellular regions (cells), including cells 302, 304, and 306, each of which may include one or more sectors. Cells may be defined geographically, e.g., by coverage area, and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector.

The cells 302, 304 and 306 may include several UEs that may be in communication with one or more sectors of each cell 302, 304 or 306. For example, UEs 330 and 332 may be in communication with Node B 342, UEs 334 and 336 may be in communication with Node B 344, and UEs 338 and 340 may be in communication with Node B 346. In the drawing of FIG. 3, UE 336 is illustrated as an electricity meter having a WWAN interface, as one example of an MTC device. Here, each Node B 342, 344, 346 is configured to provide an access point to a core network 204 (see FIG. 2) for all the UEs 330, 332, 334, 336, 338, 340 in the respective cells 302, 304, and 306.

For example, during a call with the source cell 304, or at any other time, the UE 336 may monitor various parameters of the source cell 304 as well as various parameters of neighboring cells such as cells 302 and 306. Further, depending on the quality of these parameters, the UE 336 may maintain communication with one or more of the neighboring cells.

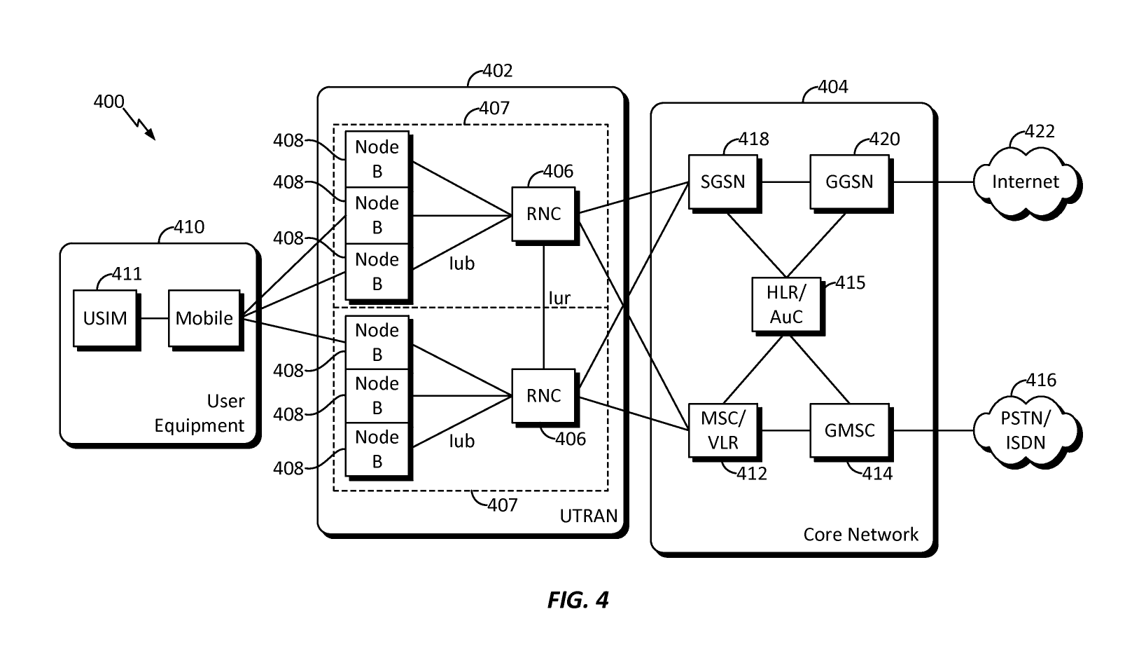

Referring now to FIG. 4, by way of example and without limitation, various aspects of the present disclosure are illustrated with reference to a Universal Mobile Telecommunications System (UMTS) system 400 employing a W-CDMA air interface. A UMTS network includes three interacting domains: a Core Network 404, a UMTS Terrestrial Radio Access Network (UTRAN) 402, and User Equipment (UE) 410. In this example, the UTRAN 402 may provide various wireless services including telephony, video, data, messaging, broadcasts, and/or other services. The UTRAN 402 may include a plurality of Radio Network Subsystems (RNSs) such as an RNS 407, each controlled by a respective Radio Network Controller (RNC) such as an RNC 406. Here, the UTRAN 402 may include any number of RNCs 406 and RNSs 407 in addition to the illustrated RNCs 406 and RNSs 407. The RNC 406 is an apparatus responsible for, among other things, assigning, reconfiguring and releasing radio resources within the RNS 407. The RNC 406 may be interconnected to other RNCs (not shown) in the UTRAN 402 through various types of interfaces such as a direct physical connection, a virtual network, or the like, using any suitable transport network.

Communication between a UE 410 and a Node B 408 may be considered as including a physical (PHY) layer and a medium access control (MAC) layer. Further, communication between a UE 410 and an RNC 406 by way of a respective Node B 408 may be considered as including a radio resource control (RRC) layer.

The geographic region covered by the RNS 407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each RNS 407; however, the RNSs 407 may include any number of wireless Node Bs. The Node Bs 408 provide wireless access points to a core network (CN) 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In some aspects of the present disclosure, the UE 410 may be an MTC device configured for machine-to-machine communications.

In a UMTS system, the UE 410 may further include a universal subscriber identity module (USIM) 411, which contains a user's subscription information to a network. For illustrative purposes, one UE 410 is shown in communication with a number of the Node Bs 408. The downlink (DL), also called the forward link, refers to the communication link from a Node B 408 to a UE 410, and the uplink (UL), also called the reverse link, refers to the communication link from a UE 410 to a Node B 408.

The Core Network 404 interfaces with one or more access networks, such as the UTRAN 402. As shown, the Core Network 404 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 404 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 404 supports circuit-switched services with a MSC 412 and a GMSC 414. In some applications, the GMSC 414 may be referred to as a media gateway (MGW). One or more RNCs, such as the RNC 406, may be connected to the MSC 412. The MSC 412 is an apparatus that controls call setup, call routing, and UE mobility functions. The MSC 412 also includes a visitor location register (VLR) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The illustrated core network 404 also supports packet-data services with a serving GPRS support node (SGSN) 418 and a gateway GPRS support node (GGSN) 420. GPRS, which stands for General Packet Radio Service, is designed to provide packet-data services at speeds higher than those available with standard circuit-switched data services. The GGSN 420 provides a connection for the UTRAN 402 to a packet-based network 422. The packet-based network 422 may be the Internet, a private data network, or some other suitable packet-based network. The primary function of the GGSN 420 is to provide the UEs 410 with packet-based network connectivity. Data packets may be transferred between the GGSN 420 and the UEs 410 through the SGSN 418, which performs primarily the same functions in the packet-based domain as the MSC 412 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 408 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

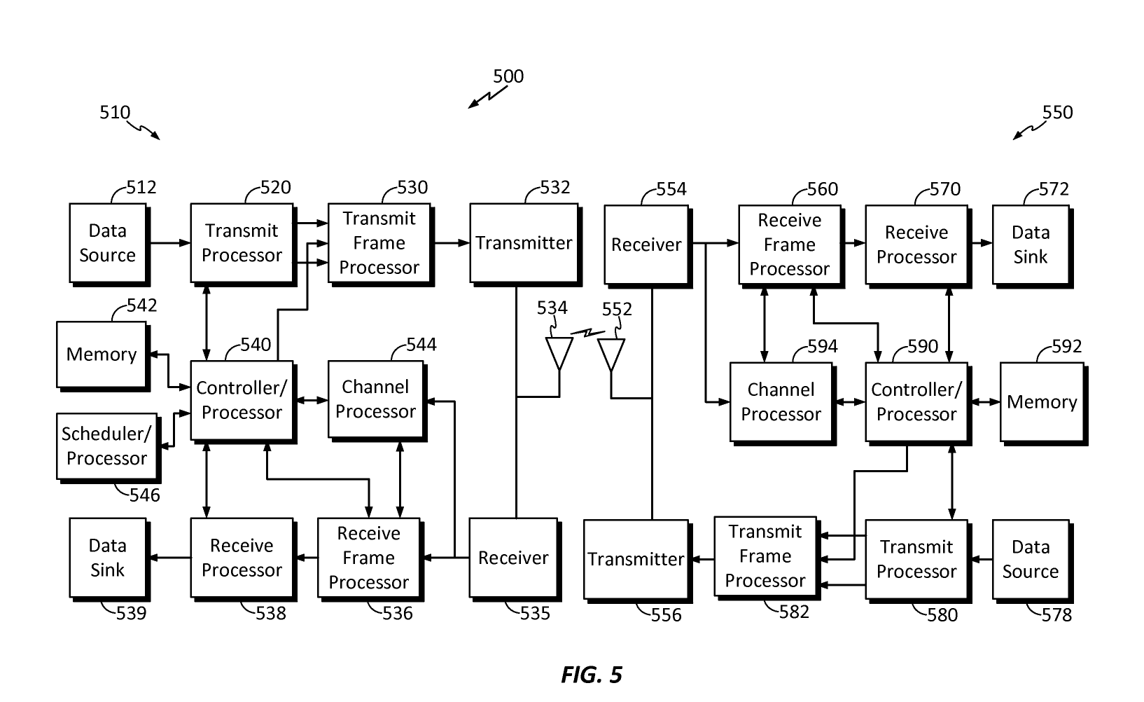

FIG. 5 is a block diagram of an exemplary Node B 510 in communication with an exemplary UE 550, where the Node B 510 may be the Node B 408 in FIG. 4, and the UE 550 may be the UE 410 in FIG. 4. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

For example, as described further below, the data sink 539 and the data source 512 may be coupled to a backhaul connection for communicating with network nodes such as an RNC or any other node in a core network. For example, the Node B 510 may utilize the data sink 539 and the data source 512 for communicating with the core network or the RNC regarding core network congestion, local traffic surges at the Node B 510, pre-configuration information corresponding to access service classes, or any other suitable information.

Further, the receiver 535 at the Node B 510 may receive access attempts from the UE 550 on the random access channel (RACH), and the transmitter 532 at the Node B 510 may transmit responses to the access attempts on an acquisition indicator channel (AICH). The transmitter 532 at the Node B may further be utilized for any other transmission such as the broadcast of an access class bit mask.

By the same token, the transmitter 556 at the UE 550 may transmit access attempts to the Node B 510 on the RACH, and the receiver 554 at the UE 550 may receive the responses to the access attempts on the AICH. The receiver 554 at the UE may further receive any other transmission from the Node B such as the broadcast of an access class bit mask.

### Access Class Barring

Access control refers to certain procedures that may be utilized to prevent an overload of radio access channels. One procedure that may be utilized for access control can be referred to as access class barring. Access class barring can be useful when an overload condition is detected at the core network, for turning off many UEs right away.

In 3GPP Re1-99 standards, the population of UEs was broken up into ten groups, called access classes. Access class numbers 0-9 may be allocated to all the UEs, and the allocated access class number may be stored in the SIM/USIM of each UE.

Access class barring refers to the broadcasting of a bit mask over the air, e.g., having 10 bits, where each bit corresponds to one access class. If a certain bit in the bit mask is set to a 0, then devices in the access class corresponding to that bit are barred from attempting to access the network. On the other hand, if the bit corresponding to an access class is set to a 1, then devices in the access class corresponding to that bit are not barred from accessing the network. In this way, groups consisting of increments of about 10% of the population of UEs can be barred from accessing the network.

An issue with existing implementations of access class barring is that even if all access classes except for one are barred, e.g., setting only one bit of the bit mask to a 1 and setting all other bits to 0, it could still be the case that the devices that are not barred happen to be the devices that are causing the overload condition. In particular, when a portion of the population of devices includes MTC devices, which might have a tendency to flood the network with access attempts in a short period of time, conventional access class barring may not be sufficient to relieve core network congestion.

Thus, in an aspect of the present disclosure a separate set of access classes may be introduced, exclusively applying to a specific category of UEs such as the low-priority devices. Here, an additional bit mask, referred to herein as an MTC bit mask for convenience, may be introduced, to be exclusively utilized by the low-priority devices. In this way, each of the low-priority devices may similarly be allocated an access class from 0-9. However, only devices that are designated as being a member of the population of low-priority devices will read the MTC bit mask. Other devices such as mobile phones, etc., can retain their mapping to access classes 0-9, but those other devices may read the pre-existing bit mask utilized for access control and ignore the MTC bit mask. In this manner, another set of access classes may be introduced, wherein this new set of access classes, applicable only to designated low-priority devices, can be controlled independently from other devices such as mobile phones, with the use of the MTC bit mask.

Thus, in an aspect of the present disclosure the low-priority devices can be controlled by access class barring without substantially affecting the behavior of other UEs such as mobile phones. In addition, the population of low-priority devices can be broken up into ten groups for granular access class barring. This access class barring approach can therefore provide a coarse granularity of access control for reducing or eliminating problems caused by a surge in traffic from the low-priority devices.

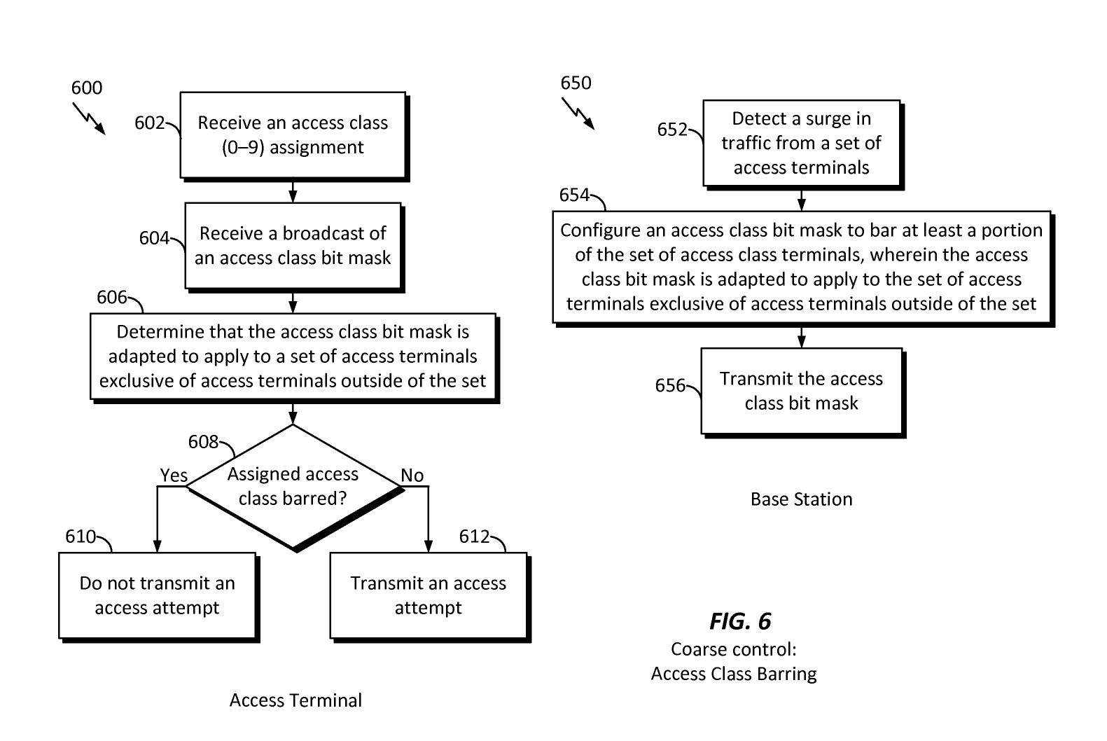

FIG. 6 is a flow chart illustrating a process 600 operable at an access terminal, and a process 650 operable at a base station, for implementing access class barring in accordance with an aspect of the present disclosure. In some examples, the process 600 may be performed by the MTC device 336 illustrated in FIG. 3. In some examples, the process 600 may be performed by the UE 410 illustrated in FIG. 4 or the UE 550 illustrated in FIG. 5. In some examples, the process 600 may be performed by the processing system 114 illustrated in FIG. 1, or by any suitable apparatus for performing the described functions.

In block 602, the access terminal may receive an access class assignment. The assignment of an access class to a particular access terminal may be performed by the network at any suitable time, or may be performed by the device manufacturer or network operator prior to deployment. In any case, the access classes may be stored locally at the access terminal, e.g., in the SIM/USIM, and in some examples may take a value from 0 to 9.

In block 604, the access terminal may receive a broadcast including an access class bit mask. As described above, the access class bit mask, e.g., the MTC bit mask, may be a bit mask that is separate and distinct from a conventional bit mask utilized in a UMTS system for access class barring. That is, the conventional bit mask may be transmitted separately and may be utilized as it has been in conventional systems. In block 606, the UE may determine that the access class bit mask received in block 604 is adapted to apply to a set of access terminals exclusive of access terminals outside of the set. That is, access terminals outside of the set might generally be configured to ignore the access class bit mask received in block 604.

In block 608, the access terminal may determine if, in accordance with the access class assignment received in block 602, the access terminal is barred by the access class bit mask received in block 604. If the received access class bit mask indicates that the access terminal is barred, then in block 610 the access terminal may not transmit an access attempt. On the other hand, if the received access class bit mask indicates that the access terminal is not barred, then in block 612 the access terminal may transmit the access attempt.

As stated above, process 650 may be operable at a base station. In some examples, the process 650 may be performed by the Node B 344 illustrated in FIG. 3, the Node B 408 illustrated in FIG. 4, or the Node B 510 illustrated in FIG. 5. In some examples, the process 650 may be performed by the processing system 114 illustrated in FIG. 1, or by any suitable apparatus for performing the described functions.

In block 652, the base station may detect a surge in traffic from low-priority devices. For example, a Node B may receive an indication from an RNC or another suitable network node indicating that the low-priority devices are causing a surge in traffic. In another example, the Node B may locally detect a surge corresponding to a large number of random access attempts or large amounts of traffic transmitted to the Node B by local low-priority devices. Here, the low-priority devices may be MTC devices or any other class of user equipment that may be designated to be a low-priority device.

In block 654, the base station may configure an access class bit mask to bar at least a portion of the set of access class terminals. Here, the access class bit mask may be adapted to apply to the set of access terminals exclusive of access terminals outside of the set. In some examples, the base station may additionally configure and transmit a second access class bit mask adapted to apply to the access class terminals outside of the set.

In block 656, the base station may transmit the access class bit mask. In this way, the portion of the set of access class terminals causing the surge in traffic can be barred from transmitting access attempts, potentially relieving congestion caused by the surge.

### RRC Connection Establishment Procedure—RRC Layer

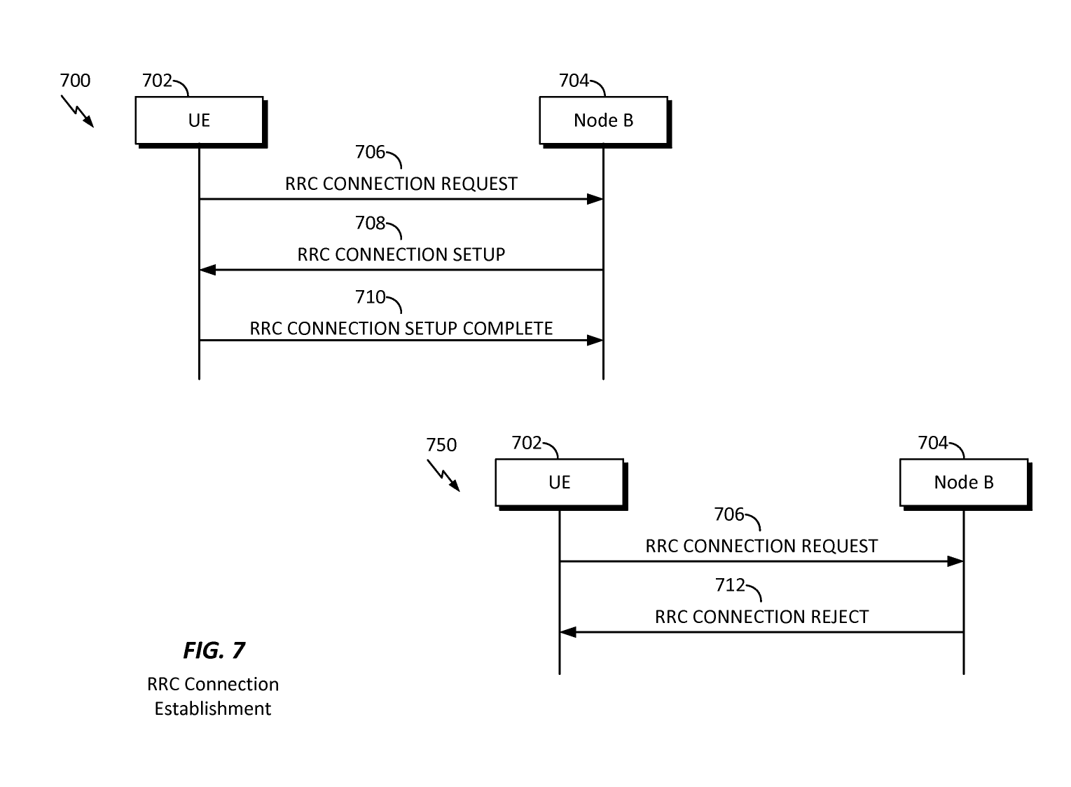

In a further aspect of the present disclosure, even with the coarse access control provided above by access class barring, there may be a desire for a finer level of control of low-priority devices. A conventional approach to access control typically referred to as reject by radio access network (reject by RAN), as described below, may be implemented at RRC connection establishment. FIG. 7 illustrates a typical RRC connection establishment procedure.

The RRC connection establishment procedure is initiated by an access terminal such as a UE 702 in Idle mode (i.e., when no RRC connection exists), when upper layers in the UE 702 request the establishment of a signaling connection.

When the RRC connection establishment procedure is initiated, the UE 702 maps its access class to an access service class (ASC), and applies the given ASC when accessing the RACH, as described in further detail below. Here, access classes are mapped to the ASCs in accordance with an information element “AC-to-ASC mapping” in the System Information Block type 5 (SIBS) or SIB5bis.

The UE 702 further transmits an RRC CONNECTION REQUEST message 706 on the uplink common control channel (CCCH), including various parameters relating to the UE 702 and the connection request.

If the network accepts the connection request, as illustrated in call flow diagram 700, it may respond by transmitting an RRC CONNECTION SETUP message 708, transmitted from the Node B 704 on the downlink CCCH and including various radio configuration information. Here, the UE 702 may enter into a connected mode and transmit the RRC CONNECTION SETUP COMPLETE message 710 on the uplink CCCH.

On the other hand, as illustrated in call flow diagram 750, if the network rejects the connection request, it may respond with an RRC CONNECTION REJECT message 712, transmitted from the Node B 704 on the downlink CCCH. In some instances the rejection message 712 may include information to direct the UE 702 to another carrier or another system. Upon rejecting a connection request, the RAN generally deletes all context information for the UE 702 that made the request.

When the UE 702 receives the rejection message, it generally waits for a time according to a “wait time” variable before attempting another connection request. In an example where the core network or the base station is overloaded, the rejection message 712 can include an extended wait time, so that the UE 702 waits for a longer time to reattempt the connection, potentially relieving the congestion.

Others have utilized RRC signaling such as the RRC CONNECTION REJECT message 712 for access control of low-priority devices. However, this approach can be expensive in highly loaded scenarios. For example, because the RNC is generally involved in the generation of RRC signaling, there can be some delay in the processing and signaling of the rejection, as well as adding to the RRC signaling load. Further, uplink resources might be considered to be wasted under this approach, since multiple low-priority UEs are generally required each to transmit the RRC CONNECTION REQUEST message 706, only to be rejected.

Thus, a further aspect of the present disclosure provides a reject by RAN procedure that may be handled at lower layers, such as the MAC layer, without necessitating RRC signaling provided by the RNC.

That is, as discussed in further detail below, aspects of the present disclosure introduce a new access service class, which may be designated as ASC 8, specifically designated for the low-priority devices. Here, by utilizing this new access service class, RACH preambles corresponding to this new ASC may be rejected at the Node B whenever the core network or the RAN is congested, and designated low-priority devices make a random access. In this way, a fine granularity of access control may be provided for low-priority devices that might contribute to congestion.

### Random Access Procedure

A conventional random access procedure is largely managed by the MAC entities at the UE and the Node B. As described below, the random access procedure utilizes, among others, channels including the BCH, RACH, and AICH.

The broadcast channel (BCH) is a transport channel that carries broadcasted information directed to any mobile in listening range. The broadcasted information may be specific to a particular cell or may concern the network. For example, the broadcasted information may include random access codes and access slots for the cell.

The random access channel (RACH) is a transport channel generally used to initiate a call with the network, or to register a terminal to the network after powering on, or for performing a location update after moving from one location to another. That is, the RACH can provide common uplink signaling messages, and also can carry dedicated uplink signaling and user information from a UE operating in a Cell_FACH state. At the physical layer, the RACH maps to the physical random access channel (PRACH).

The acquisition indicator channel (AICH) is transmitted by the base station to indicate the reception of the RACH signature sequence. That is, once the base statin detects a PRACH preamble, the base station transmits the AICH including the same signature sequence as used on the PRACH. The AICH generally includes an information element called the acquisition indicator (AI), which may include a positive acknowledgment (ACK) or a negative acknowledgment (NACK) indicating an acceptance or a rejection of the received access attempt.

The PRACH, transmitted by the UE, includes a preamble that is transmitted before data transmission on that channel. The PRACH preamble contains a signature sequence of 16 symbols which, combined with a spreading sequence having a spreading factor of 256, results in a PRACH preamble with a length of 4096 chips.

The RACH resources (i.e., the time slots generally referred to as access slots, and the preamble signatures) are conventionally divided among a number of access service classes (ASCs). Access classes (described above) are mapped to the ASCs in accordance with an information element “AC-to-ASC mapping” in the System Information Block type 5 (SIBS) or SIB5bis. By utilizing the ASCs, different priorities for RACH resource usage may be given to different classes of user equipment by allocating more resources to higher priority classes than to lower priority classes. That is, the network generally assigns sets of RACH sub-channels and signatures according to the ASC of the UE. According to 3GPP standards, there are a maximum of eight ASCs numbered ASC 0 to ASC 7, with ASC 0 indicating the highest priority and ASC 7 indicating the lowest priority. It is allowed for more than one ASC, even up to all the ASCs to be assigned to the same access slot or signature.

Here, each ASC may be associated with a certain persistence value. The persistence value for a particular ASC is generally derived by the RRC entity in accordance with a dynamic persistence level broadcasted on SIB7 and a persistence scaling factor broadcasted on SIBS, SIB5bis, or SIB6. These persistence values are used to control the number of uplink access attempts of RACH transmissions.

Further, all of the ASCs ASC 0-ASC 7 are characterized by a set of RACH transmission parameters, NB01min and NB01max. These RACH transmission parameters are used when a UE tries to connect to the network and is rejected. Here, the UE may apply the appropriate back-off time as a wait time before trying again. The back-off time is determined in accordance with the RACH transmission parameters NB01min and NB01max. Here, NB01min corresponds to a lower bound for a back-off time, and NB01max corresponds to an upper bound for the back-off time. That is, the back-off time utilized by a particular UE corresponds to a random time selected within the range [NB01min, NB01max].

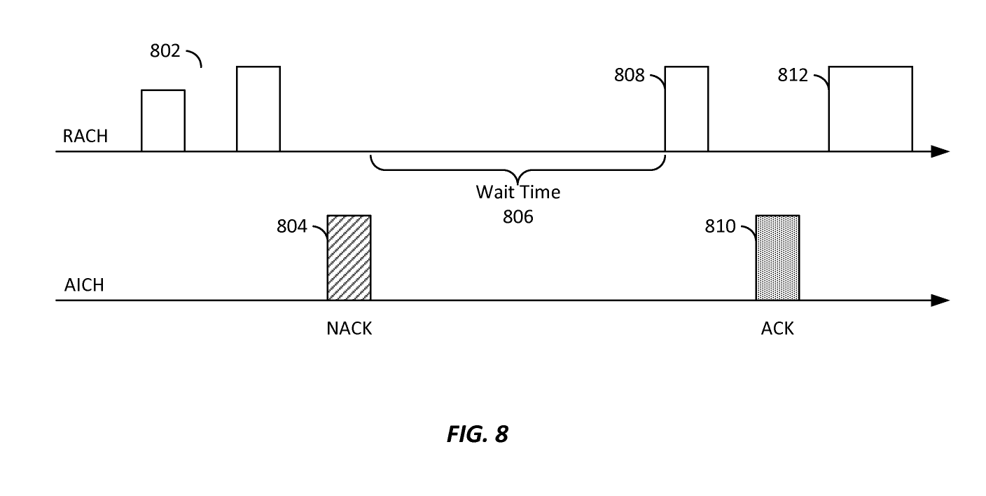

For example, FIG. 8 illustrates a typical random access procedure in a UTRA network. Here, the random access procedure begins with a UE decoding the BCH to determine the available RACH sub-channels and their scrambling codes and signatures. The UE may then randomly select one of the RACH sub-channels from among the group of sub-channels that the UE's ASC allows it to use. The signature may also be selected randomly from among the signatures available for the given ASC.

After setting the PRACH power level, the UE transmits the PRACH preamble 802 with the selected signature. In the illustration of FIG. 8, the PRACH preamble includes two transmissions with a ramping of the power in each transmission not acknowledged by the network. When the PRACH preamble 802 is detected, the Node B may respond with an acquisition indication (AI) 804 indicating a negative acknowledgment on the AICH. Here, the UE stops its transmission, re-trying again later (if the number of access attempts corresponding the persistence value has not been exhausted) after waiting for a wait time 806 equal to the back-off period, randomly selected from within the range [NB01min, NB01max]. After waiting, if the number of attempts allowed according to the persistence value for the UE has not been exhausted, the UE may transmit a subsequent PRACH preamble 808 on the PRACH. In this instance, the access attempt is met with a positive acknowledgment 810 transmitted by the Node B on the AICH. Here, the AICH includes the same signature sequence transmitted by the UE. Once the UE detects the AICH acknowledgment, it may transmit the message part 812 of the RACH transmission.

### New Access Service Class

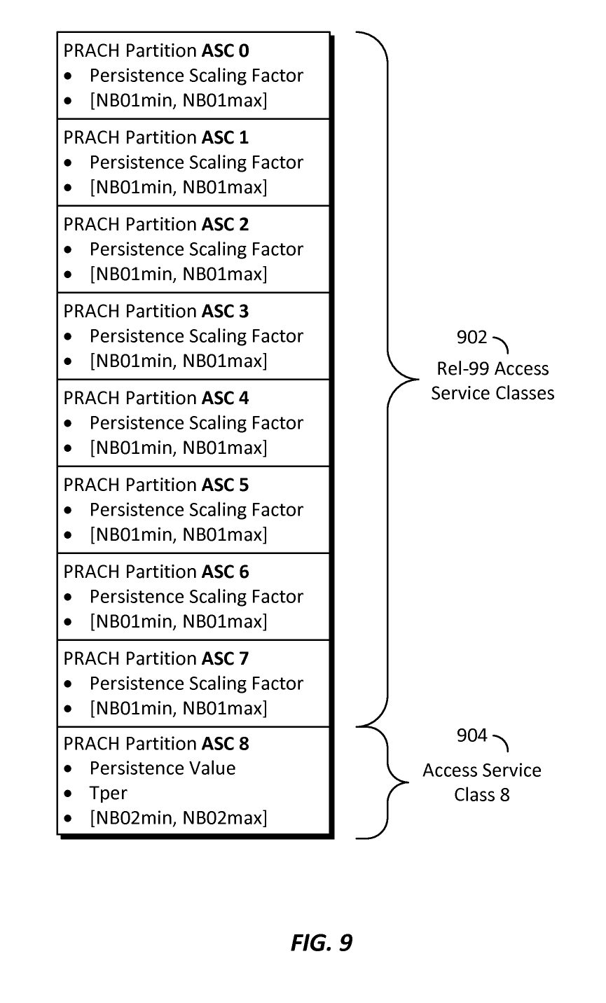

FIG. 9 is a schematic illustration of access service classes in accordance with an aspect of the present disclosure. That is, a new access service class 904, which may be designated as ASC 8, may be established for utilization by low-priority devices such as the MTC devices. That is, the RACH resources may be partitioned such that a UE with the new ASC 904 (ASC 8) can be controlled substantially independently of a UE in any other access service class 902 ASC 0-ASC 7.

For example, a low-priority UE allocated to ASC 8 may always utilize a different signature than any UE in any other ASC (ASC 0-ASC 7). Further, a low-priority UE allocated to ASC 8 may always utilize different sub-channels than any UE in any other ASC (ASC 0-ASC 7). Still further, a low-priority UE allocated to ASC 8 may always utilize different access slots than any other UE in any other ASC (ASC 0-ASC7). That is, one or more RACH parameters may be partitioned such that ASC 8 may be allocated respective RACH parameters exclusively of any other access service class. In some examples in accordance with various aspects of the present disclosure, the UEs allocated to ASC 8 may only utilize some, or even only one, of the exclusive parameters such as the signature space allocation, the sub-channel allocation, or the access slot allocation.

Thus, in accordance with an aspect of the present disclosure, a random access attempt by the low-priority UE in ASC 8 may quickly be rejected by the Node B when the Node B is made aware of congestion at the core network.

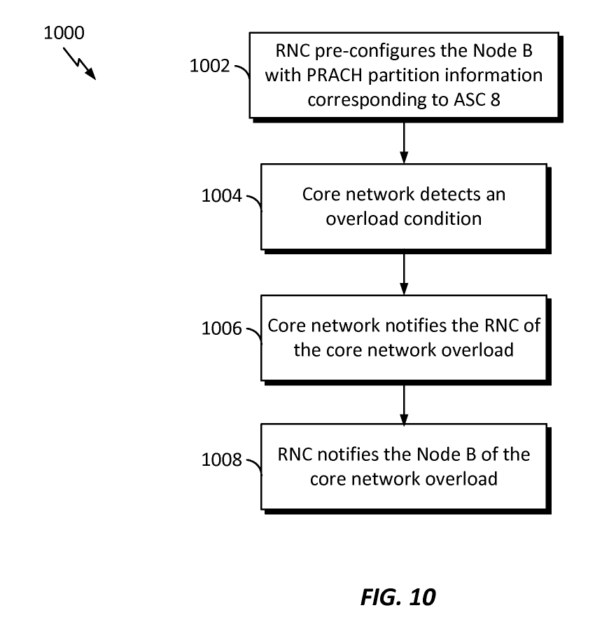

FIG. 10 is a simplified flow chart illustrating one example for configuring a Node B to handle random access attempts by low-priority UEs amid potential overload conditions in accordance with an aspect of the present disclosure. The illustrated process 1000 is a generalized process implemented by various nodes in the network such as a Core Network 404, an RNC 406, and a Node B 408, as illustrated in FIG. 4.

In block 1002, the RNC may pre-configure the Node B with PRACH partition information corresponding to ASC 8. In this way, the Node B can recognize random access attempts by UEs allocated to ASC 8 and control them independently of UEs in other access service classes.

In block 1004, the core network may detect an overload condition. That is, when an overload condition, which may be related to the use of the MTC devices occurs at the core network, the core network may notify the RNC of the overload condition. In block 1006 the core network may notify the RNC of the core network overload condition, and in block 1008 the RNC may send a notification to the Node B indicating the overload condition at the core network.

In this fashion, the Node B may be configured to respond to the overload condition by access class barring (as described above with reference to FIG. 6) or with a reject by RAN approach, described below.

That is, being aware of the core network overload condition, when the Node B receives a PRACH preamble transmitted by the low-priority UE utilizing one of the signatures allocated to ASC 8, the Node B may send a NACK on the corresponding AICH. That is, as described above, the RACH resources include the signature space utilized in the PRACH preamble. When the signature space is partitioned among the various access service classes, in accordance with an aspect of the present disclosure, the signatures allocated to ASC 8 may be made exclusive of any other access service class. In this way, the Node B can be made to reject random access attempts from the low-priority devices utilizing the signature designated for ASC 8, without necessarily needing to reject random access attempts from other UEs utilizing one of the signatures allocated to ASC 0-ASC 7.

Further, signaling the rejection on the AICH, which is broadcasted and is readable by all the UEs in listening range, can provide a NACK to a plurality of low-priority UEs in the scenario where many low-priority devices collide on the same signature.

Similarly, the Node B that is aware of the core network overload condition may reject random access attempts from low-priority devices by detecting any of the PRACH partition information exclusively associated with ASC 8. That is, in addition to the exclusive partition of the signature space utilized in the transmission of the PRACH preamble, ASC 8 may be allocated one or more of exclusive access slots or sub-channels utilized in the random access procedure. In this way, in an aspect of the present disclosure the Node B may send a NACK on a corresponding AICH in response to a random access attempt by a low-priority device in accordance with the detection of an access slot or a sub-channel designated exclusively for ASC 8.

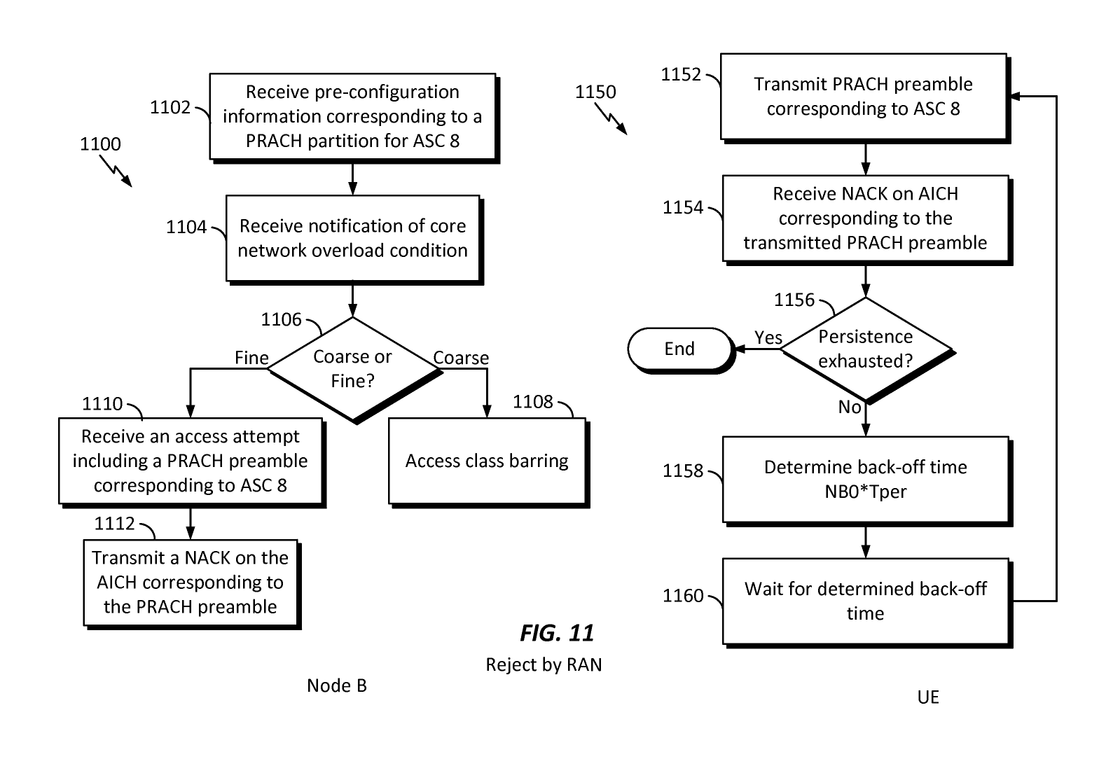

FIG. 11 is a flow chart illustrating a process 1100 operable at a base station, and a process 1150 operable at an access terminal, for a reject by RAN process in accordance with some aspects of the present disclosure. In some examples, the process 1100 may be performed by the Node B 344 illustrated in FIG. 3, the Node B 408 illustrated in FIG. 4, or the Node B 510 illustrated in FIG. 5. In some examples, the process 1100 may be performed by the processing system 114 illustrated in FIG. 1, or by any suitable apparatus for performing the described functions.

In block 1102, the base station may receive pre-configuration information corresponding to a PRACH partition for ASC 8, i.e., the access service class exclusively allocated to a set of access terminals. For example, the set of access terminals can include the low-priority, MTC devices. The pre-configuration information may be received at the base station from the RNC, and may include information such as the signatures or sub-channels exclusively allocated to ASC 8. In block 1104, the base station may receive a notification of an overload condition corresponding to the set of access terminals. Here, the overload condition may be a core network overload, detected by any suitable node associated with the core network, which merits a suitable access control procedure. In another example, the overload condition may be a RAN overload, e.g., experienced by the Node B itself. In this instance, the Node B would notify the network, and the notification received in block 1104 may be a notification that the overload detected by the Node B in fact does constitute an overload that merits a suitable access control procedure.

In block 1106, the process may determine whether the suitable access control procedure is coarse access control or fine access control. The determination whether to implement coarse or fine control may be based on any suitable set of factors, such as the nature of the overload condition, its magnitude, its origin, or whether prior access control attempts have or have not successfully relieved the overload condition. Further, the determination may be made locally at the Node B, or may be made at some other node. That is, in some examples, the notification received at the Node B in block 1104 may further include instructions or information relating to the decision between coarse or fine access control. Here, if the process determines that the coarse level of access control is appropriate, then in block 1108 the process may implement access class barring, as described above in association with FIG. 6.

On the other hand, if in block 1106 the process determines that the fine level of access control is appropriate, then in block 1110, when the Node B receives an access attempt including a PRACH preamble corresponding to the access service class exclusively allocated to the set of access terminals (e.g., the MTC devices), the Node B may respond in block 1112 by transmitting a negative acknowledgment (NACK), e.g., on the AICH, corresponding to the received PRACH preamble to reject the access attempt. For example, the NACK may be transmitted utilizing the same signature utilized to transmit the access attempt.

As stated above, process 1150 may be operable at an access terminal. In some examples, the process 1150 may be performed by the MTC device 336 illustrated in FIG. 3. In some examples, the process 1150 may be performed by the UE 410 illustrated in FIG. 4 or the UE 550 illustrated in FIG. 5. In some examples, the process 1150 may be performed by the processing system 114 illustrated in FIG. 1, or by any suitable apparatus for performing the described functions.

In block 1152, the access terminal may transmit an access attempt, e.g., utilizing the random access procedure described above including the transmission of a PRACH preamble corresponding to an access service class exclusively allocated to a set of access terminals (e.g., the MTC devices). Here, the access service class, e.g., ASC 8, may be characterized by at least one random access parameter that is exclusive of any other access service class. For example, as described above, the signature space may be partitioned such that signatures designated for ASC 8 are exclusive of any other access service class. Similarly, the sub-channels utilized for the random access procedure may be partitioned such that sub-channels designated for ASC 8 are exclusive of any other access service class.

In some examples, as described above with respect to FIG. 8, the transmission of the access attempt may include additional steps not described in detail herein, such as determining a suitable power level for the PRACH preamble transmission and ramping of the power when a response is not received. Those of ordinary skill in the art will comprehend that various other levels of detail may be included in the transmission of the access attempt.

In response to the transmission of the PRACH preamble in block 1152, if the network is congested, it is possible that the network may reject the access attempt. In this case, in block 1154 the access terminal may receive a negative acknowledgment (NACK) on the AICH, corresponding to the transmitted PRACH preamble.

In a further aspect of the present disclosure, ASC 8 can further be characterized by additional RACH transmission parameters that may be independent of other access service classes. For example, these RACH transmission parameters exclusive to ASC 8 may include one or more of a persistence value, a persistence multiplier, or lower and upper bounds for random back-off times.

For example, in an aspect of the disclosure, ASC 8 may be characterized by the a new persistence value separate from persistence values utilized in ASC 0-ASC 7. As described above, a persistence value may be used to control the number of uplink access attempts of RACH transmissions. Here, the persistence value utilized for ASC 8 may be a static value broadcasted, e.g., on SIBS or SIB5bis; or the persistence value utilized for ASC 8 may be a dynamic value broadcasted on SIB7. In this manner, in accordance with an aspect of the present disclosure, the low-priority devices corresponding to ASC 8 can have a different persistence value independent of any persistence values utilized by any other access service class ASC 0-ASC 7.

Thus, in block 1156 the access terminal may determine, in accordance with a persistence value, whether a limit to the number of uplink access attempts is exhausted. Here, the persistence value may be exclusively allocated by the low-priority devices corresponding to ASC 8.

### Extended Randomized Back-Off Time

In a further aspect of the present disclosure, ASC 8 may be characterized by new RACH transmission parameters NB02min and NB02max. Note that each of ASC 0-ASC 7 are characterized by RACH transmission parameters NB01min and MB01max, as described above. Here, by utilizing different parameters NB02min and NB02max in the new access service class designated for the low-priority devices, an additional level of control of the back-off times may be provided for the low-priority devices without affecting the back-off times utilized for higher priority devices in ASC 0-ASC 7.

Further, ASC 8 may be characterized by a RACH transmission parameter called a persistence multiplier Tper. The persistence multiplier Tper may be utilized with the RACH transmission parameters NB02min and NB02max to generate an extended back-off time. For example, when a low-priority UE receives a NACK on the AICH, the UE may select a value NB02, this value being randomly selected from within the range [NB02min, NB02max]. The selected value NB02 may be multiplied with the persistence multiplier Tper to determine the back-off time. That is, the back-off time may be equal to (NB02)*Tper.

Here, in accordance with an aspect of the present disclosure, substantially the same effect as achieved by setting the extended wait time in the RRC CONNECTION REJECT message, as described above, may be achieved by sending the NACK on the AICH. That is, by setting the RACH transmission parameters [NB02min, NB02max] and Tper to suitable values for a relatively long back-off time, the low-priority UE receiving the NACK on the AICH can wait for an extended time before applying a random back-off prior to a subsequent random access attempt.

Thus, in block 1158, in response to receiving the negative acknowledgment at the access terminal in block 1154, the access terminal may determine a back-off time to wait before initiating the next access attempt. Here, the back-off time may be determined as described above in accordance with a selection of a value NB02, selected randomly from within the range [NB02min, NB02max], multiplied with the value of the persistence multiplier Tper.

In block 1160, the access terminal may wait for the back-off time determined in block 1158, before returning to block 1152 to transmit another access attempt.

While the fine granularity provided by the reject by RAN approach described above, which relies upon the exclusive access service class for the low-priority devices can provide improvement to access control, it may be desired to utilize some aspects of this approach without necessarily utilizing the exclusive access service class ASC 8. That is, the rapid handling of access attempts by devices at the Node B, without necessarily relying on the RNC to provide RRC signaling for the RRC rejection approach, may be more broadly desired for access control. Thus, in a further aspect of the present disclosure, the Node B may be enabled to send negative acknowledgments on the AICH in response to access attempts by UEs corresponding to one or more ASCs, which may or may not include the exclusive access service class ASC 8.

In a further aspect of the present disclosure, the process of rejecting the access attempts may be modified to reject only a certain percentage of the access attempts, in order to throttle the number of UEs accessing the network in certain heavy loading conditions. That is, in accordance with various factors, for example, whether the loading at the core network or at the RAN is greater than a certain threshold (e.g., a predetermined threshold), the Node B may reject some of the access attempts corresponding to factors such as the access service class (or classes) utilized by the UEs attempting to access the network, while letting a certain percentage of the UEs of those same access classes through to access the network. In this way, while traffic can be throttled to manage the overload condition, at least a portion of the UEs may be enabled to access the network to prevent a total outage.

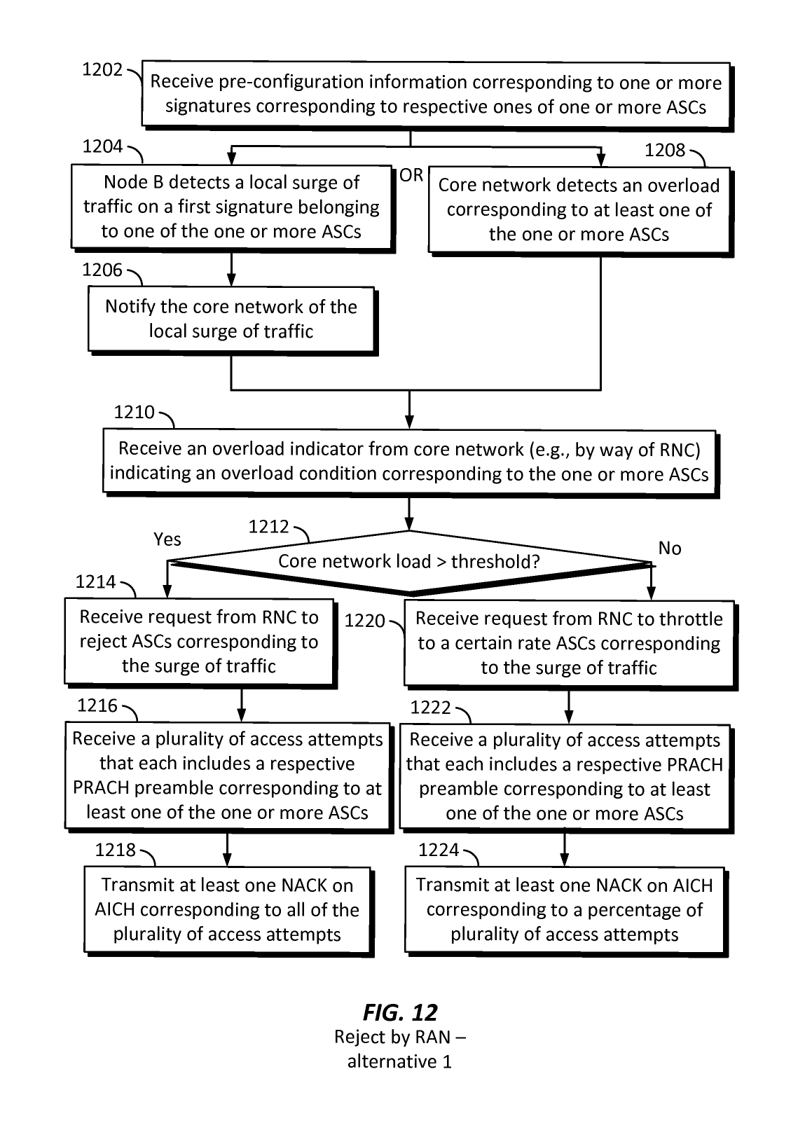

FIG. 12 is a flow chart illustrating a process 1200 operable at a base station for access control in accordance with an aspect of the present disclosure. In some examples, the process 1200 may be performed by the Node B 344 illustrated in FIG. 3, the Node B 408 illustrated in FIG. 4, or the Node B 510 illustrated in FIG. 5. In some examples, the process 1200 may be performed by the processing system 114 illustrated in FIG. 1, or by any suitable apparatus for performing the described functions.

In block 1202, the base station may receive pre-configuration information corresponding to one or more signatures, each of which corresponds to a respective one of one or more access service classes. Here, the one or more access service classes may or may not necessarily include the new access service class ASC 8 introduced in the present disclosure. The pre-configuration information may be received at the base station from the RNC, and may include information such as the signatures or sub-channels corresponding to the one or more access service classes.

Following the receiving of the pre-configuration information in block 1202, the process may proceed to block 1204, wherein the base station may detect a local surge of traffic on a first signature belonging to one of the one or more access service classes for which the base station is pre-configured in block 1202. For example, if a large number of access terminals transmit access attempts to the base station within a relatively short period of time, where those access terminals correspond to the first signature, the Node B may detect this activity as a local surge of traffic. In block 1206, the base station may notify the core network of the local surge of traffic. For example, a notification may be sent to the core network, by way of the RNC, including information pertaining to the detected surge of traffic.

In another example, in addition to or instead of locally detecting the traffic surge, as indicated in block 1208 the core network may detect an overload condition corresponding to at least one of the one or more ASCs for which the base station is pre-configured in block 1202.

In either case, the process may proceed to block 1210, wherein the base station may receive an overload indicator from the core network indicating an overload condition corresponding to the one or more access service classes. Here, if the base station locally detected the surge of traffic and notified the core network of this circumstance, the overload indicator received in block 1210 may be a response to this notification, indicating that the local surge of traffic may correspond to a core network overload condition. In some examples, the overload indicator received from the core network may be omitted, and the local detection of the surge of traffic may suffice to result in the access control precautions discussed below.

In block 1212, the process may determine whether the core network load, corresponding to the overload indicator received in block 12120, is greater than a threshold. For example, this determination may be made at the core network itself, and the overload indicator received in block 1210 may provide this information. In another example, the base station may make this determination in accordance with a magnitude of the local surge of traffic. In any case, if the core network load is large enough, the process may proceed to block 1214, wherein the base station may receive a request, e.g., from the RNC, to reject all access attempts from devices corresponding to the access service classes that may be causing the surge of traffic. Here, the receiving of the request from the RNC in block 1214 may be optional; and in another example, the request from the RNC may be in response to additional communication between the base station and the RNC. In block 1216, the base station may receive one or more access attempts that each includes a respective PRACH preamble corresponding to at least one of the one or more ASCs that are causing the surge in traffic. In block 1218, the base station may transmit at least one NACK on the AICH corresponding to all of the plurality of access attempts. Here, the NACK may be a single NACK transmitted on the AICH, since the nature of this channel can provide a one-to-many advantage if, for example, each of the plurality of access attempts received in block 1216 utilized the same signature sequence. In this way, the base station may block all access attempts in response to surge in traffic.

On the other hand, if in block 1212 the process determines that the core network load is not greater than the threshold, the process may proceed to block 1220. Here, the base station may receive a request, e.g., from the RNC, to throttle to a certain rate the access service classes corresponding to the detected surge in traffic. That is, rather than rejecting all access attempts as described above, another aspect of the present disclosure may provide for the rejection of a certain percentage of the access attempts to throttle the surge in traffic. Thus, in block 1222, the base station may receive a plurality of access attempts that each includes a respective PRACH preamble corresponding to at least one of the one or more ASCs for which the base station is preconfigured in block 1202. In block 1224, the base station may transmit at least one NACK on the AICH corresponding to a percentage of the plurality of access attempts received in block 1222. Here, the percentage may be a predetermined percentage, such as for example blocking half or 50% of all access attempts to throttle to half ASCs corresponding to the surge of traffic.

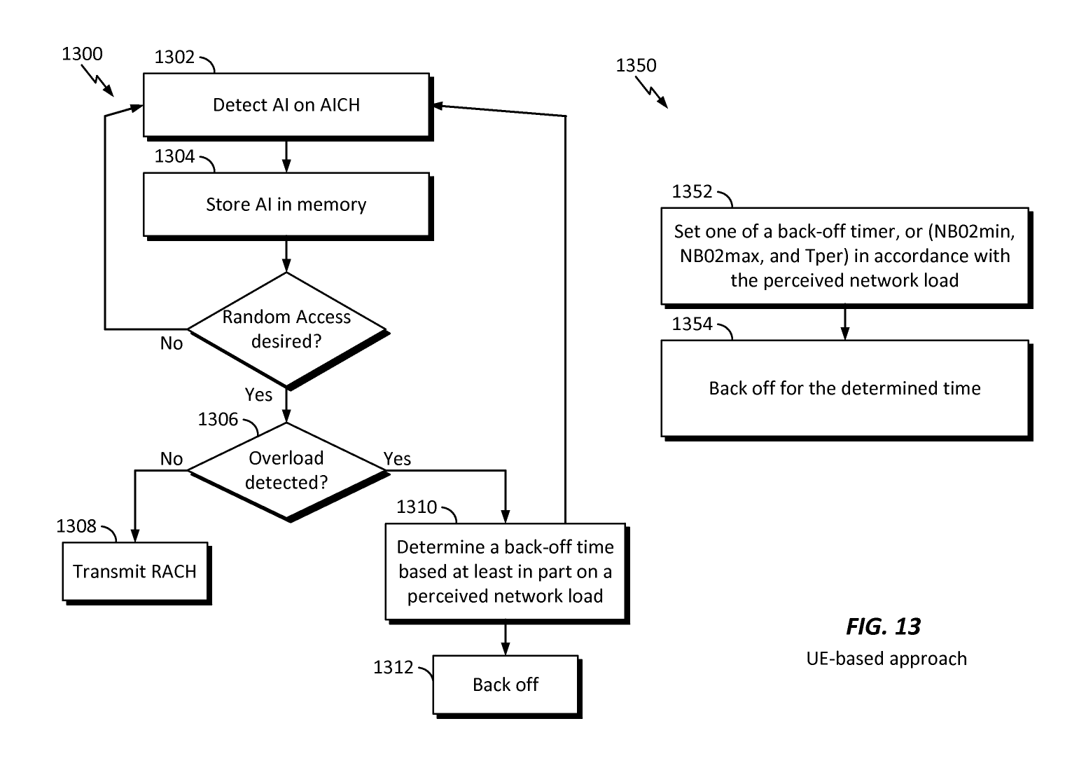

FIG. 13 is a flow chart illustrating aspects of a further example of a reject by RAN procedure in accordance with the present disclosure. With this approach, the access terminal can proactively detect that a local surge in traffic or an overload condition is occurring. In this instance, the access terminal may back off without transmitting an access attempt, thereby not further contributing to the overload condition.

For example, processes 1300 and 1350 may each be operable at an access terminal. In some examples, the processes 1300 and 1350 may be performed by the MTC device 336 illustrated in FIG. 3. In some examples, the processes 1300 and 1350 may be performed by the UE 410 illustrated in FIG. 4 or the UE 550 illustrated in FIG. 5. In some examples, the processes 1300 and 1350 may be performed by the processing system 114 illustrated in FIG. 1, or by any suitable apparatus for performing the described functions.

In block 1302, the access terminal may monitor the AICH and detect the AI information elements included in the AICH. In block 1304, the access terminal may store the detected AIs in a memory. This process may repeat any number of times, such that an array of AIs may be stored in the memory for analysis by the access terminal at a time when upper layers determine to instruct the lower layers to transmit a random access attempt.

At a time when upper layers in the access terminal request establishment of a connection, in block 1306, the access terminal may determine whether an overload condition is detected. For example, an overload condition may correspond to a high percentage of NACKs being transmitted by the base station. For example, if the access terminal detects N NACKs out of M AICH slots, where N/M is greater than a threshold (e.g., a predetermined threshold), the access terminal may interpret this as an overload condition. In another example, the overload condition may correspond to a certain number of consecutive NACKs. That is, if the access terminal detects a sequence of NACKs greater than a threshold (e.g., a predetermined threshold), the access terminal may interpret this as an overload condition.

If the access terminal does not detect the overload condition, then in block 1308, the access terminal may decide to transmit the access attempt on the RACH. On the other hand, if the access terminal detects the overload condition in block 1306, then in block 1310 the access terminal may decide to back off for a certain period of time, and may transmit the access attempt at a later time.

As a part of the back-off process in block 1310, the access terminal may determine a back-off time. In a further aspect of the present disclosure, the back-off time may be based at least in part on a perceived network load at the access terminal.

Process 1350 illustrates some further details of block 1310 for determining the back-off time. That is, in some examples, in block 1352, the access terminal may simply set a back-off timer based on a characteristic of the perceived network load. For example, the back-off time may be determined by utilizing an equation relating to the percentage of negative acknowledgments. Of course, any suitable relationship between the perceived network load and the back-off timer may be utilized. In another example, in block 1352 the access terminal may set a value of at least one of a lower bound NB02min or an upper bound NB02max for a back-off parameter NB02, wherein the back-off parameter NB02 is selected from within a range bounded by [NB02min, NB02max]. Here, at least one of the lower or upper bounds may be set in accordance with the perceived network load. In this example, the back-off time may be determined in accordance with a product of the back-off parameter NB02 and a persistence multiplier Tper.

In block 1354, the access terminal may back off for the time determined in block 1352 prior to attempting to transmit an access attempt to the base station.

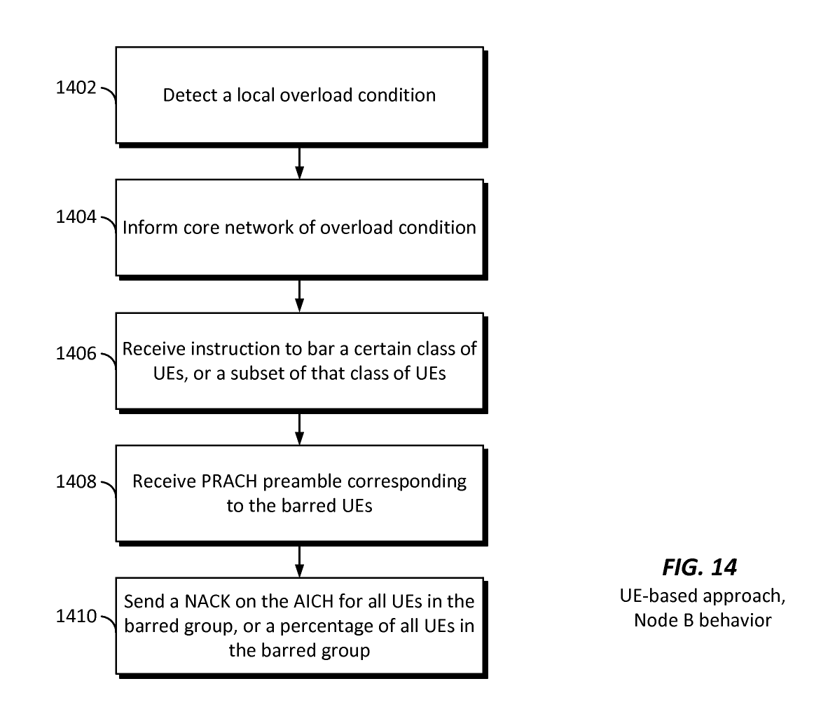

FIG. 14 illustrates some further aspects of the present disclosure relating to base station behavior under the approach illustrated in FIG. 13, wherein the access terminal is utilized for detecting an overload condition. That is, in some aspects of the present disclosure, when the access terminal detects the overload condition as described above in connection with FIG. 13, it may inform the base station of the perceived overload condition. Thus, in block 1402, the base station may detect the existence of the overload condition, e.g., by receiving an indication corresponding to the perceived overload condition from one or more access terminals. In block 1404, the base station may inform the core network of the detected overload condition. Based on this signal from the base station, and potentially based on other information, the core network may determine that the perceived overload condition corresponds to a true overload condition that merits the blocking of at least some access attempts at the base station. In this case, in block 1406 the base station may receive an instruction to bar at least a portion of access terminals utilizing a first access service class. Here the first access service class may correspond to information received from the one or more access terminals, such as information that that particular access service class is receiving the negative acknowledgments on the AICH. Further, in some examples, the first access service class may include at least one random access parameter that is exclusive of any other access service class, e.g., as described above with respect to ASC 8.

In block 1408, the base station may receive an access attempt including a PRACH preamble corresponding to the first access service class. Here, based on the instruction received in block 1406, in block 1410 the base station may transmit a negative acknowledgment on the AICH corresponding to the received PRACH preamble. Further, as described above in relation to FIG. 13, the base station may transmit one or more NACKs corresponding to all the access terminals in the barred group, or a percentage of all the access terminals in the barred group.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to a random access procedure in other UMTS systems such as those configured for Enhanced Uplink (EUL) in CELL_FACH state and Idle mode, or to other UMTS air interfaces such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication operable at an access terminal, comprising:
receiving a plurality of acquisition indicators each indicating one of a positive acknowledgment or a negative acknowledgement corresponding to a respective access attempt by one or more access terminals;
storing the acquisition indicators in a memory;
determining an overload condition in accordance with the stored acquisition indicators; and
backing off from transmitting an access attempt in accordance with the overload condition.

2. The method of claim 1, wherein the determining of the overload condition comprises determining that a percentage of the acquisition indicators greater than a threshold indicate the negative acknowledgment.

3. The method of claim 1, wherein the determining of the overload condition comprises determining that greater than a threshold number of negative acknowledgments have been received in sequence.

4. The method of claim 1, wherein the backing off comprises:
determining a back-off time based at least in part on a perceived network load corresponding to the overload condition.

5. The method of claim 4, wherein the determining of the back-off time comprises:
setting a value of at least one of a lower bound or an upper bound for a back-off parameter, wherein the back-off parameter is selected from within a range bounded by the lower bound and the upper bound,
wherein the back-off time comprises a product of a persistence multiplier and the back-off parameter.

6. A method of wireless communication operable at a base station, comprising:
detecting the existence of an overload condition;
transmitting an indicator of the overload condition to a core network;
receiving an instruction to bar at least a portion of access terminals utilizing a first access service class; and
barring at least a portion of access attempts from the access terminals utilizing the first access service class.

7. The method of claim 6, further comprising:
receiving a PRACH preamble corresponding to the first access service class;
transmitting a negative acknowledgment on an acquisition indicator channel corresponding to the received PRACH preamble.

8. An access terminal configured for wireless communication, comprising:
means for receiving a plurality of acquisition indicators each indicating one of a positive acknowledgment or a negative acknowledgement corresponding to a respective access attempt by one or more access terminals;
means for storing the acquisition indicators;
means for determining an overload condition in accordance with the stored acquisition indicators; and
means for backing off from transmitting an access attempt in accordance with the overload condition.

9. The access terminal of claim 8, wherein the means for determining the overload condition comprises means for determining that a percentage of the acquisition indicators greater than a threshold indicate the negative acknowledgment.

10. The access terminal of claim 8, wherein the means for determining the overload condition comprises means for determining that greater than a threshold number of negative acknowledgments have been received in sequence.

11. The access terminal of claim 8, wherein the means for backing off is configured to determine a back-off time based at least in part on a perceived network load corresponding to the overload condition.

12. The access terminal of claim 11, wherein the determining of the back-off time comprises:
means for setting a value of at least one of a lower bound or an upper bound for a back-off parameter, wherein the back-off parameter is selected from within a range bounded by the lower bound and the upper bound;
wherein the back-off time comprises a product of a persistence multiplier and the back-off parameter.

13. A base station configured for wireless communication, comprising:
means for detecting the existence of an overload condition;
means for transmitting an indicator of the overload condition to a core network;
means for receiving an instruction to bar at least a portion of access terminals utilizing a first access service class; and
means for barring at least a portion of access attempts from the access terminals utilizing the first access service class.

14. The base station of claim 13, further comprising:
means for receiving a PRACH preamble corresponding to the first access service class;
means for transmitting a negative acknowledgment on an acquisition indicator channel corresponding to the received PRACH preamble.

15. A computer program product operable at an access terminal configured for wireless communication, comprising:
a computer-readable medium comprising:
instructions for causing a computer to receive a plurality of acquisition indicators each indicating one of a positive acknowledgment or a negative acknowledgement corresponding to a respective access attempt by one or more access terminals;
instructions for causing a computer to store the acquisition indicators in a memory;
instructions for causing a computer to determine an overload condition in accordance with the stored acquisition indicators; and
instructions for causing a computer to back off from transmitting an access attempt in accordance with the overload condition.

16. The computer program product of claim 15, wherein the instructions for causing a computer to determine the overload condition comprise instructions for causing a computer to determine that a percentage of the acquisition indicators greater than a threshold indicate the negative acknowledgment.

17. The computer program product of claim 15, wherein the instructions for causing a computer to determine the overload condition comprise instructions for causing a computer to determine that greater than a threshold number of negative acknowledgments have been received in sequence.

18. The computer program product of claim 15, wherein the instructions for causing a computer to back off comprise instructions for causing a computer to determine a back-off time based at least in part on a perceived network load corresponding to the overload condition.

19. The computer program product of claim 18, wherein the instructions for causing a computer to determine the back-off time comprise:
instructions for causing a computer to set a value of at least one of a lower bound or an upper bound for a back-off parameter, wherein the back-off parameter is selected from within a range bounded by the lower bound and the upper bound,
wherein the back-off time comprises a product of a persistence multiplier and the back-off parameter.

20. A computer program product operable at a base station configured for wireless communication, comprising:
a computer-readable medium comprising:
instructions for causing a computer to detect the existence of an overload condition;
instructions for causing a computer to transmit an indicator of the overload condition to a core network;
instructions for causing a computer to receive an instruction to bar at least a portion of access terminals utilizing a first access service class; and
instructions for causing a computer to bar at least a portion of access attempts from the access terminals utilizing the first access service class.

21. The computer program product of claim 20, wherein the computer-readable medium further comprises:
instructions for causing a computer to receive a PRACH preamble corresponding to the first access service class;
instructions for causing a computer to transmit a negative acknowledgment on an acquisition indicator channel corresponding to the received PRACH preamble.

22. An access terminal configured for wireless communication, comprising:
a receiver for receiving a plurality of acquisition indicators each indicating one of a positive acknowledgment or a negative acknowledgement corresponding to a respective access attempt by one or more access terminals;
at least one processor; and
a memory coupled to the at least one processor,
wherein the at least one processor is configured to:
store the acquisition indicators in a memory;
determine an overload condition in accordance with the stored acquisition indicators; and
back off from transmitting an access attempt in accordance with the overload condition.

23. The access terminal of claim 22, wherein the determining of the overload condition comprises determining that a percentage of the acquisition indicators greater than a threshold indicate the negative acknowledgment.

24. The access terminal of claim 22, wherein the determining of the overload condition comprises determining that greater than a threshold number of negative acknowledgments have been received in sequence.

25. The access terminal of claim 22, wherein the backing off comprises determining a back-off time based at least in part on a perceived network load corresponding to the overload condition.

26. The access terminal of claim 25, wherein the determining of the back-off time comprises setting a value of at least one of a lower bound or an upper bound for a back-off parameter, wherein the back-off parameter is selected from within a range bounded by the lower bound and the upper bound, and wherein the back-off time comprises a product of a persistence multiplier and the back-off parameter.

27. A base station configured for wireless communication, comprising:
at least one processor; and
a memory coupled to the at least one processor,
wherein the at least one processor is configured to detect the existence of an overload condition;
the base station further comprising a transmitter for transmitting an indicator of the overload condition to a core network, and a receiver for receiving an instruction to bar at least a portion of access terminals utilizing a first access service class,
wherein the at least one processor is further configured to bar at least a portion of access attempts from the access terminals utilizing the first access service class.

28. The base station of claim 27,
wherein the receiver is further configured to receive a PRACH preamble corresponding to the first access service class, and
wherein the transmitter is further configured to transmit a negative acknowledgment on an acquisition indicator channel corresponding to the received PRACH preamble.
